(19) United States
(12) Patent Application Publication
(10) Pub. No.: US 2021/0072800 A1
(43) Pub. Date: Mar. 11, 2021

(54) HINGE STRUCTURE

(71) Applicants: Che-Hsien Lin, Taipei City (TW); Che-Hsien Chu, Taipei City (TW)

(72) Inventors: Che-Hsien Lin, Taipei City (TW); Che-Hsien Chu, Taipei City (TW)

(73) Assignee: COMPAL ELECTRONICS, INC., Taipei City (TW)

(21) Appl. No.: 17/063,723

(22) Filed: Oct. 6, 2020

Related U.S. Application Data
(62) Division of application No. 16/232,060, filed on Dec. 26, 2018.
(60) Provisional application No. 62/610,280, filed on Dec. 26, 2017.

(51) Int. Cl. G06F 1/16; E05D 3/12; E05D 5/10; E05D 11/08; E05D 11/06; F16C 11/04

(52) U.S. Cl. CPC G06F 1/1681; E05D 3/12; E05D 5/10; E05D 11/082; E05D 11/06; E05Y 2201/218; F16C 11/04; E05Y 2201/25; E05Y 2900/606; E05D 2005/106; G06F 1/1616

(57) ABSTRACT

A hinge structure connected between two bodies of an electronic device is provided. The bodies are rotated to be folded or unfolded relatively through the hinge structure. The hinge structure includes a first rotating shaft, a second rotating shaft, and a torsion member that the first and the second rotating shafts being pivoted thereto, such that the torsion member surrounds and grasps an axial surface of the first rotating shaft and an axial surface of the second rotating shaft respectively. The first rotating shaft has a first actuating portion and a second actuating portion. The second rotating shaft has a third actuating portion and a fourth actuating portion. The torsion member has a first torsion providing portion located on a moving path of the first and the second actuating portions and a second torsion providing portion located on a moving path of the third and the fourth actuating portions.

### CROSS-REFERENCE TO RELATED APPLICATION

This application is a divisional application of and claims the priority benefit of U.S. application Ser. No. 16/232,060, filed on Dec. 26, 2018, which claims the priority benefit of U.S. provisional application Ser. No. 62/610,280, filed on Dec. 26, 2017. The entirety of each of the above-mentioned patent applications is hereby incorporated by reference herein and made a part of this specification.

### BACKGROUND

### Technical Field

The disclosure relates to a hinge structure.

### Description of Related Art

Generally, an electronic device, such as a mobile phone or a notebook computer, has bodies with a pivot or a hinge, such that the bodies could be rotated back and forth by the pivot or the hinge upon receiving an external force to be folded or unfolded.

In the abovementioned pivot or the hinge structure, regarding the adjustment of friction plates or a gasket, a required torsion is obtained by controlling fastening and packing level of a fastener or a nut. If the level of adjustment is too loose, the hinge structure would not obtain an ideal effects of body positioning; if the level of adjustment is too tight, a problem of deformation is likely to be occurred due to the concentration of the stress; meanwhile, the inappropriate level of adjustment would also cause users feel that the operation is laborious and the handling is not ideal.

However, in any situation mentioned above, the torsion is specified upon the completion of the assembling of the components. In other words, the torsion of the hinge structure does not have the possibility to be adjusted according to the usage requirement; therefore, the possibility of development of the body structure is limited.

### SUMMARY

The disclosure provides a hinge structure adapted to connect bodies of an electronic device, wherein a torsion generated by the torsion providing portion may change along with the rotation of the rotating shaft and the torsion member correspondingly to be released after the bodies being folded.

The hinge structure of the disclosure is suitable for being connected between two bodies of an electronic device, and the bodies rotates relatively through the hinge structure to be folded or unfolded. The hinge structure includes a first rotating shaft, a second rotating shaft and a torsion member. The first rotating shaft is assembled to one body, and the first rotating shaft has a first actuating portion and a second actuating portion. The second rotating shaft is assembled to another body, and the second rotating shaft has a third actuating portion and a fourth actuating portion. The first rotating shaft and the second rotating shaft may be rotatably disposed in the torsion member respectively. The torsion member respectively surrounds and grasps an axial surface of the first rotating shaft and an axial surface of the second rotating shaft. The torsion member has a first torsion providing portion and a second torsion providing portion. The first torsion providing portion is located on a moving path of the first actuating portion and the second actuating portion; and the second torsion providing portion is located on a moving path of the third actuating portion and the fourth actuating portion. The torsion generated by the first torsion providing portion abutting the first actuating portion is smaller than the torsion generated by the first torsion providing portion abutting the second actuating portion. The torsion generated by the second torsion providing portion abutting the third actuating portion is smaller than the torsion generated by the second torsion providing portion abutting the fourth actuating portion.

Based on the above of the disclosure, the adaptability of related structures of the electronic device could be increased through a torsion variation of the hinge structure so as to meet the requirement of rotation of the bodies. Particularly, when the bodies of the electronic device are in a folded state, the torsion of the hinge structure may be decreased or released to avoid the deformation of the bodies, and the bodies of the electronic device could further meet the design trend of slim and light.

In order to make the features and advantages of the disclosure mentioned above more understandable, embodiments will be described in detail below with reference to the accompanying drawings.

### BRIEF DESCRIPTION OF THE DRAWINGS

FIG. 1A is a schematic view of an electronic device according to an embodiment of the disclosure.

FIG. 1B is a side view of the electronic device of FIG. 1A.

FIG. 1C is a side view of an electronic device of existing technology.

FIG. 2A and FIG. 2B are explosive views of the hinge structure of FIG. 1A in different viewing angles.

FIG. 2C is a schematic view of components of the hinge structure of FIG. 1A in another viewing angle.

FIG. 3A to FIG. 3F are schematic views of different angles of the hinge structure while the bodies being folded or unfolded.

FIG. 4A to FIG. 4B are respectively partial schematic views of the hinge structure in different states.

FIG. 4C is a partial schematic view of the hinge structure in another state.

FIG. 4D is a partial schematic view of the hinge structure of another embodiment of the disclosure.

FIG. 5 is a partial side view of the hinge structure of another embodiment of the disclosure.

FIG. 6A and FIG. 6B are explosive views of the hinge structure of another embodiment of the disclosure.

FIG. 6C is a partial side view of the torsion member in FIG. 6A or FIG. 6B.

FIG. 7 is a partial schematic view of the hinge structure of another embodiment of the disclosure.

### DESCRIPTION OF THE EMBODIMENTS

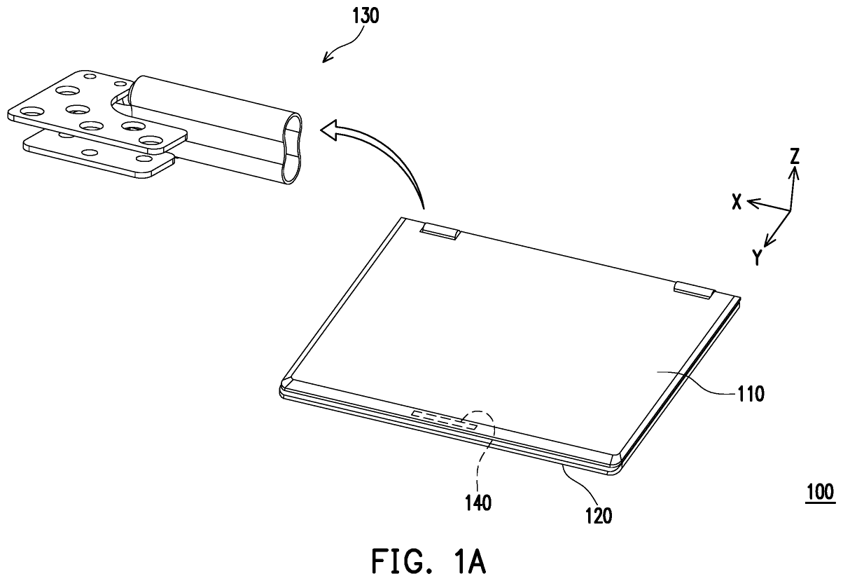

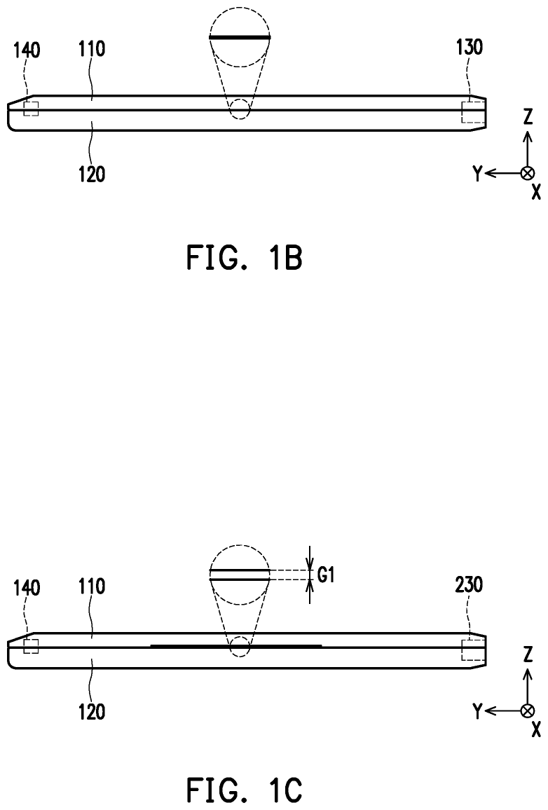

FIG. 1A is a schematic view of an electronic device according to an embodiment of the disclosure. FIG. 1B is a side view of the electronic device of FIG. 1A. FIG. 1C is a side view of an electronic device of existing technology. Please refer to FIG. 1A and FIG. 1B first, in the present embodiment, an electronic device 100 is, for example, a notebook computer including a first body 110, a second body 120 and a hinge structure 130 connected between the two bodies 110 and 120. The first body 110 and the second body 120 are rotated relatively through the hinge structure 130 to be folded or unfolded. Meanwhile, the torsion generated by the hinge structure 130 may support the bodies 110 and 120 of the electronic device 100 in an unfolded state. Please refer FIG. 1B and FIG. 1C next. As mentioned above, the hinge structure of the existing technology obtains the required torsion mentioned above to support the bodies via the friction between the friction plates; thus, once the assembly is completed, the torsion that the hinge structure can generate is fixed and unchangeable. Therefore, as shown in FIG. 1C, when the notebook computer is in a folded state, the first body 110 is substantially folded upon the second body 120, but the hinge structure 230 may still provide torsion to the first body 110; and the torsion is still existed at the moment may cause the first body 110 to generate a warping and to form a gap G1, particularly, when a magnetic attraction or a buckle structure 140 is disposed to the electronic device 100, as shown in FIG. 1A, to the first body 110, the gap G1 would further present a trend of expansion if the abovementioned torsion is still existed when the body is closed,. In addition, the existing notebooks mostly follow the design trend of slim and light; therefore, if the hinge structure with fixed torsion is provided, a more obvious state of deformation would be occurred in the body.

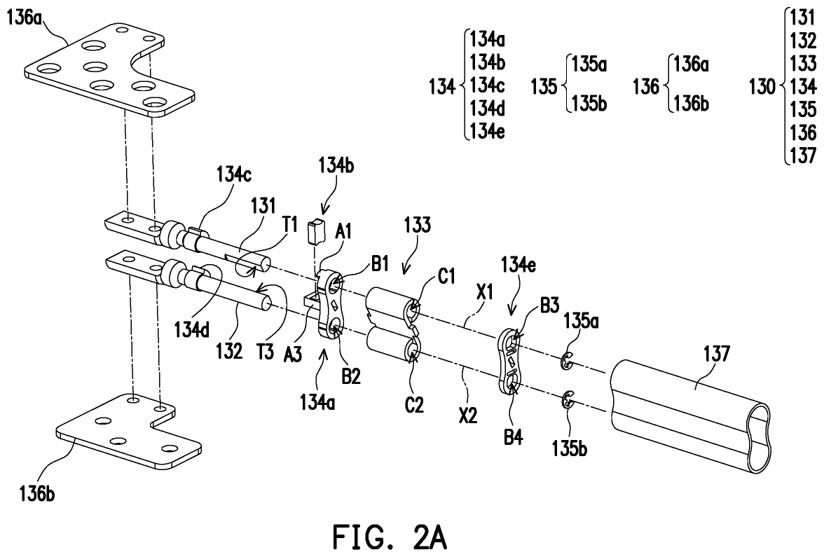

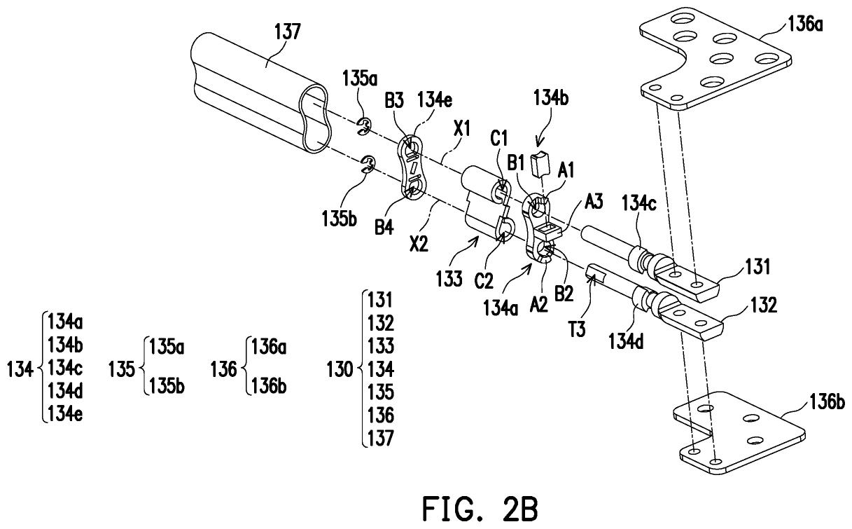

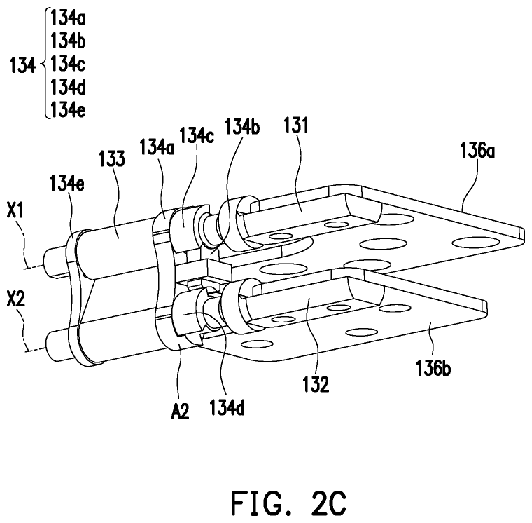

FIG. 2A and FIG. 2B are explosive views of the hinge structure of FIG. 1A in different viewing angles. Based on the above, the hinge structure 130 of the disclosure includes a first rotating shaft 131, a second rotating shaft 132, a torsion member 133, a switching assembly 134, a fixing assembly 135, a supporting assembly 136, and an outer cover 137, wherein the supporting assembly 136 includes brackets 136a and 136b. The first rotating shaft 131 is assembled into the first body 110 through the bracket 136a, and the second rotating shaft 132 is assembled into the second body 120 through the bracket 136b. Further, the first rotating shaft 131 and the second rotating shaft 132 are respectively and sequentially disposed through a limiting member 134a of the switching assembly 134, the torsion member 133, and a torsion adjusting member 134e, wherein the torsion member 133 is embedded between the limiting member 134a and the torsion adjusting member 134e, and then the limiting member 134a, the torsion member 133 and the torsion adjusting member 134e are buckled to the first rotating shaft 131 with the a component 135a, such as a C type snap ring, of the fixing assembly 135; meanwhile, the limiting member 134a, the torsion member 133 and the torsion adjusting member 134e are buckled to the second rotating shaft 132 with another component 135b, such as another C type snap ring, of the fixing assembly 135. What is required to be explained is that the first rotating shaft 131 and the second rotating shaft 132 of the present embodiment are respectively and freely disposed through (pivoted to) the limiting member 134a and the torsion adjusting member 134e. In other words, the required torsion comes from the corresponding relationship of the first rotating shaft 131, the second rotating shaft 132, and the torsion member 133. A further explanation will be described in the following description.

FIG. 2C is a schematic view of the components of the hinge structure of FIG. 1A in another viewing angle. Please refer to FIG. 2A to FIG. 2C simultaneously. In the present embodiment, the switching assembly 134 includes a switching member 134b, a third limiting portion 134c, a fourth limiting portion 134d and the aforementioned limiting member 134a as well as the torsion adjusting member 134e, wherein the contours of opposite two ends of the switching member 134b are respectively fitted to an axial surface of the first rotating shaft 131 and an axial surface of the second rotating shaft 132. The third limiting portion 134c is disposed on the first rotating shaft 131, the fourth limiting portion 134d is disposed on the second rotating shaft 132; and the limiting member 134a has a first limiting portion A1 and a second limiting portion A2. After the first rotating shaft 131 and the second rotating shaft 132 being disposed through a first guiding hole B1 and a second guiding hole B2 of the limiting member 134a, the first limiting portion A1 is located on the rotating path of the third limiting portion 134c, and the second limiting portion A2 is located on the rotating path of the fourth limiting portion 134d. The switching member 134b is movably disposed in a side frame A3 of the liming member 134a so as to move between the first rotating shaft 131 and the second rotating shaft 132. When the first rotating shaft 131 and the second rotating shaft 132 rotate about the axes X1 and X2 respectively, the aforementioned third limiting portion 134c and the fourth limiting portion 134d also rotate along with the first rotating shaft 131 and the second rotating shaft 132 so as to drive the switching member 134b to move back and forth between the axes X1 and X2 accordingly. Further, the first rotating shaft 131 and the second rotating shaft 132 are respectively and continuously disposed trough a first torsion hole C1 and a second torsion hole C2 of the torsion member 133 as well as a third torsion hole B3 and a fourth torsion hole B4 of the torsion adjusting member 134e. In the present embodiment, the torsion adjusting member 134e and the switching member 134b are respectively disposed at opposite two sides of the limiting member 134b. In the present embodiment, the torsion adjusting member 134e is used for releasing the stress when the first rotating shaft 131 and the second rotating shaft 132 rotate to a specific angle (when the flat surface of the rotating shaft and the flat surface of the torsion adjusting member are leaning against each other) to achieve the effects of decreasing the torsion. The structural feature of the torsion adjusting member 134e will be further described in the following description.

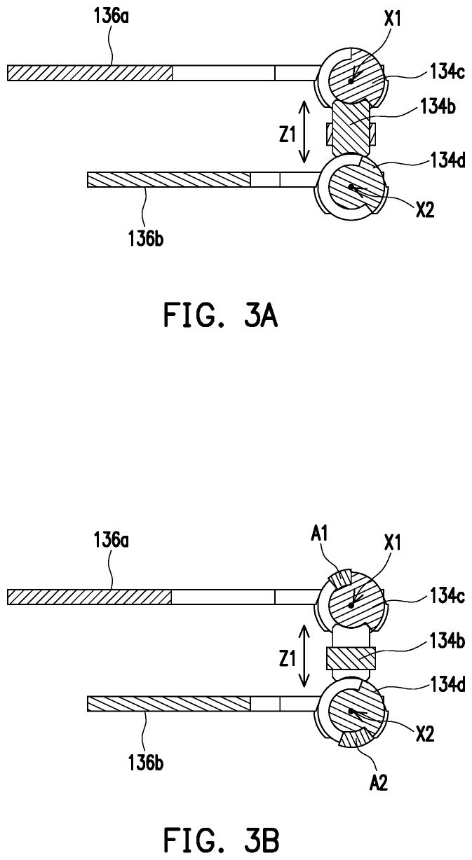

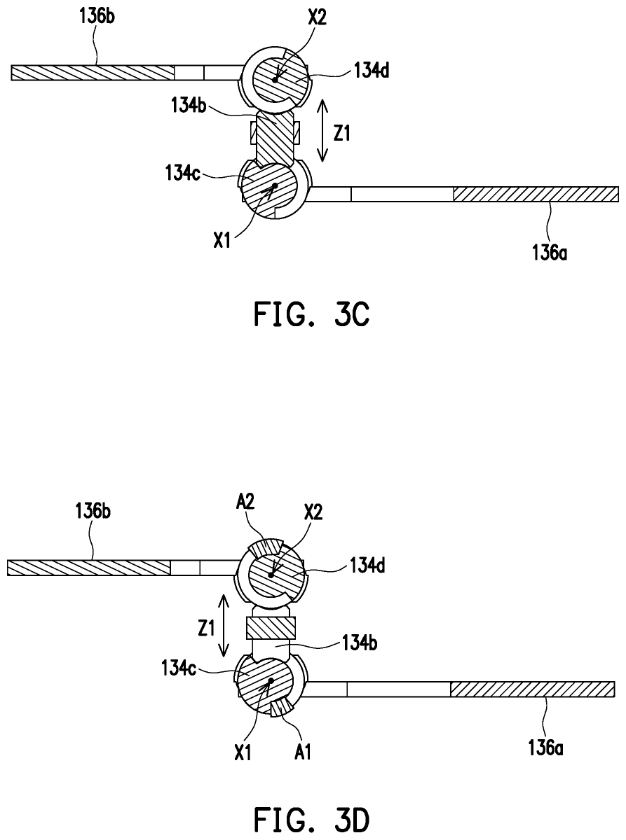

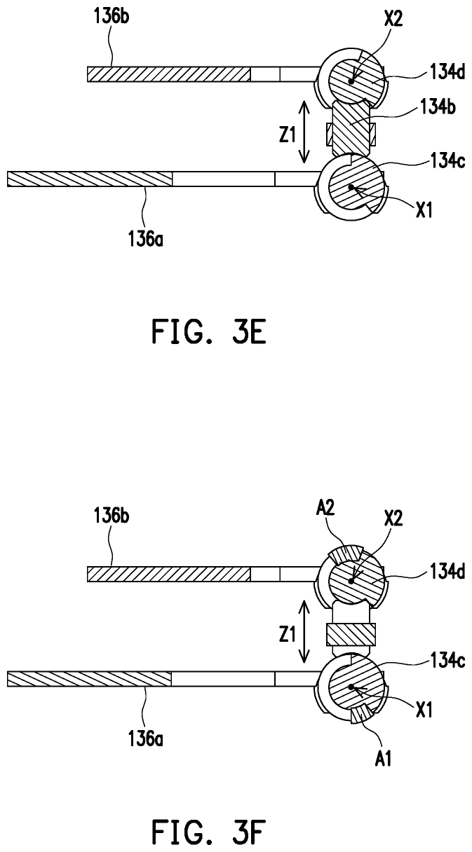

FIG. 3A to FIG. 3F are schematic views of different angles of the hinge structure along while the bodies being folded or unfolded. In the present embodiment, It is defined as “0 degree” based on the folded state shown in FIG. 1A (FIG. 2C) which is also shown in sectional views of FIG. 3A and FIG. 3B. Please refer to FIG. 2C, FIG. 3A and FIG. 3B simultaneously, wherein FIG. 3A is a sectional view of the switching member 134b, which depicts the corresponding relationship of the switching member 134b, the third limiting portion 134c and the fourth limiting portion 134d. FIG. 3B depicts the relationship of the third limiting portion 134c and the fourth limiting portion 134d respectively corresponding to the first limiting portion A1 and the second limiting portion A2 of the limiting member 134a.

FIG. 3C and 3D show an unfolded state of the electronic device 100, and the deployment angle is defined as “180 degree”. Please refer to FIG. 3A and FIG. 3C simultaneously. It can be known that during the clockwise rotating process of the first body 110 of the electronic device 100 through receiving an applied force of an user to unfold from the state of “0 degree” to the state of “180 degree”, the third limiting portion 134c and the switching member 134b shown by FIG. 3A are structurally interfered with each other, and the switching member 134b leans against the fourth limiting portion 134d simultaneously; therefore, the switching member 134b is substantially limited to the shown location of FIG. 3A and cannot move between the axes X1 and X2 (along the axis Z1). Moreover, a structural interference does not exist on the clockwise moving path of the second limiting portion A2 shown by FIG. 3B. Therefore, during the process of switching from the state of “0 degree” to the state of “180 degree”, the hinge structure 130 rotates through the second rotating shaft 132, it also means that the rotating action of the hinge structure 130 at the moment is performed about the axis X2, which means that the relative position of the first body 110, the bracket 136a, the first rotating shaft 131, the switching assembly 134, the torsion member 133 and the fixing assembly 135 has not been changed.

Further, as shown in FIG. 3D, the second limiting portion A2 may not be able to continue to rotate in a clockwise direction at the moment due to the block (interference) of the fourth limiting portion 134d. However, to the switching member 134b, the fourth limiting portion 134d disposed on the second rotating shaft 132 is not on the moving path of the switching member 134b. Therefore, the continued applied force of the user to the first body 110 represents that the third limiting portion 134c may further push the switching member 134b to the top along the axis Z1 to make the switching member 134b to change to be fitted to the second rotating shaft 132 when the support 136a continues to receive the applied force to rotate in a clockwise direction continuously. During the unfolding process (FIG. 3C to FIG. 3E, and FIG. 3D to FIG. 3F), the applied force of the user continue to drive the first body 110, and the hinge structure 130 are rotated about the axis X1 only, until the third limiting portion 134c is blocked by the first limiting portion A1. Thus, the unfolding process of the electronic device 100 from “0 degree” to “360 degree” is completed. What is required to be explained is that performing the abovementioned steps in a reverse sequence may allow the electronic device 100 to restore to the folded state shown in FIG. 1A.

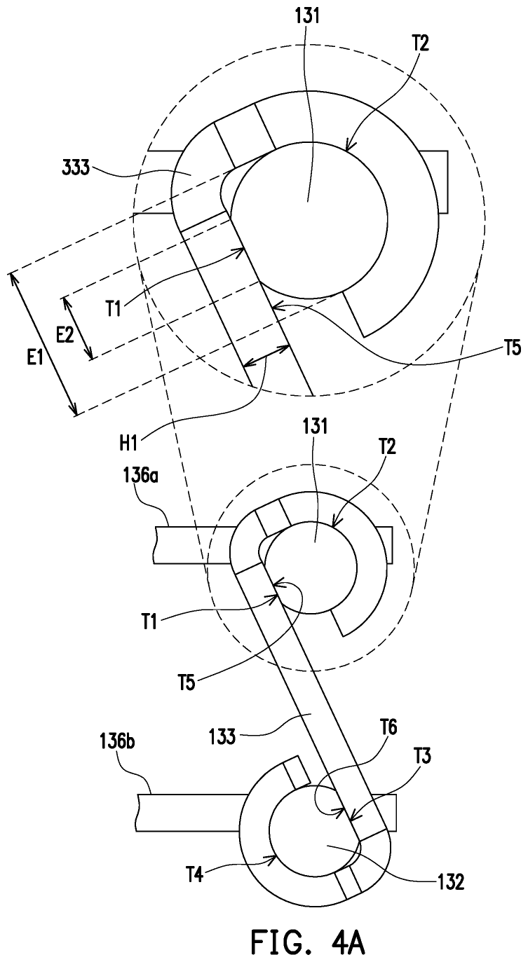

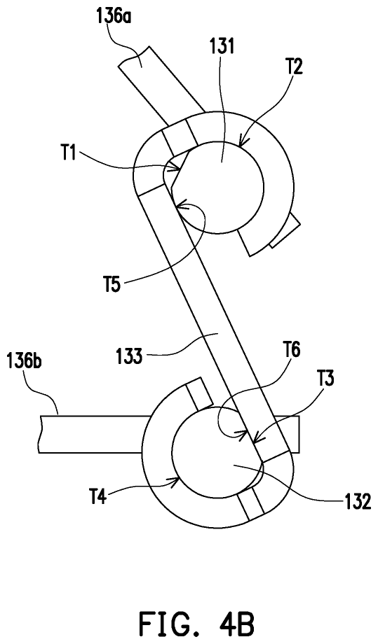

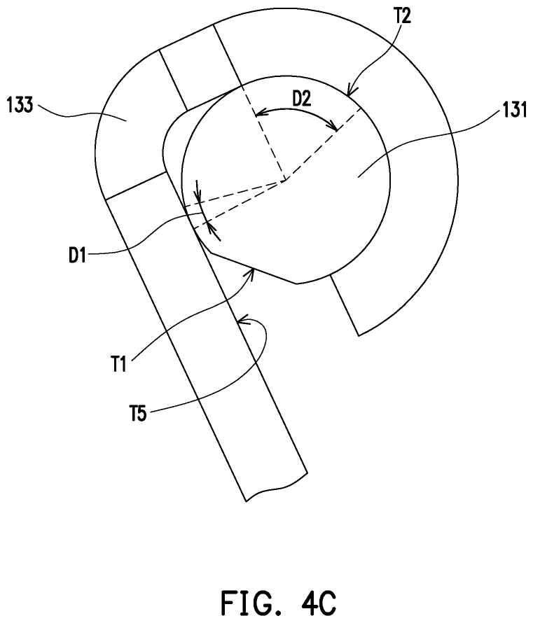

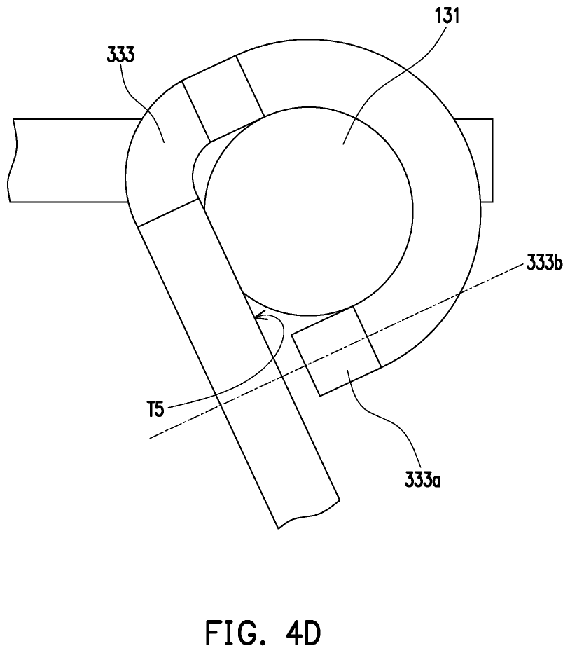

After the aforementioned rotating process shown by FIG. 3A to FIG. 3F being confirmed, a corresponding feature of the rotating shaft and the torsion member may be provided accordingly. FIG. 4A to FIG. 4B are respectively partial schematic views of the hinge structure in different states. Please refer to FIG. 2A, FIG. 4A and FIG. 4B. In the present embodiment, the first rotating shaft 131 has a first actuating portion T1 and a second actuating portion T2. The second rotating shaft 132 has a third actuating portion T3 and a fourth actuating portion T4. The first rotating shaft 131 and the second rotating shaft 132 are rotatably disposed in a first torsion hole C1 and a second torsion hole C2 of the torsion member 133 respectively, and the torsion member 133 respectively surrounds and grasps the axial surface of the first rotating shaft 131 and the axial surface of the second rotating shaft 132. The torsion member 133 has a first torsion providing portion T5 and a second torsion providing portion T6, and the first torsion providing portion T5 is on a moving path of the first actuating portion T1 and the second actuating portion T2, and the second torsion providing portion T6 is on a moving path of the third actuating portion T3 and the fourth actuating portion T4. In the present embodiment, the first actuating portion T1 is a flat portion of the axial surface of the first rotating shaft 131, and the third actuating portion T3 is a flat portion of the axial surface of the second rotating shaft 132. The first torsion providing portion T5 is a flat hole wall of the first torsion hole C1, and the second torsion providing portion T6 is a flat hole wall of the second torsion hole C2.

To the first rotating shaft 131, the axial surface thereof is formed by the first actuating portion T1 and the second actuating portion T2. In addition, the second actuating portion T2 is a cylindrical surface, and a closed contour on a cross-section of the first rotating shaft 131 is formed by the second actuating portion T2 (the cylindrical surface) and the first actuating portion T1 (the flat portion). Similarly, to the second shaft 132, the axial surface thereof is formed by the third actuating portion T3 and the fourth actuating portion T4. In addition, the fourth actuating portion T4 is a cylindrical surface, and a closed contour on a cross-section of the second rotating shaft 132 is formed by the fourth actuating portion T4 (the cylindrical surface) and the third actuating portion T3 (the flat portion).

In the present embodiment, a cross section of the first torsion hole C1 and a cross-section of the second torsion hole C2 are respectively wrapping open structure. In other words, the torsion holes (C1 and C2) may generate a deformation of different levels due to the difference of the rotating shaft and the hole wall contour during the process of the rotation. Meanwhile, it can be clearly known by comparing the change of the first rotating shaft 131 corresponding to the first torsion hole C1 shown by FIG. 4A and FIG. 4B, the torsion generated by the first torsion providing portion T5 abutting against the first actuating portion T1 is smaller than the torsion generated by the first torsion providing portion T5 abutting against the second actuating portion T2, and the torsion generated by the second torsion providing portion T6 abutting against the third actuating portion T3 is smaller than the torsion generated by the second torsion proving portion T6 abutting against the fourth actuating portion T4. In other words, the first rotating shaft 131 in a state shown by FIG. 4A, which is the state of “0 degree”, the torsion generated by the torsion member 133 and the first rotating shaft 131 is obviously smaller than the state shown by FIG. 4B, which is the state that the first rotating shaft 131 has rotated in a specific rotational angle. Since the second rotating shaft 132 would deform the second torsion hole C2 as shown by the first rotating shaft 131, the details would not be described again here. Based on the above, through the non-round contour of cross-section, the torsion member 133 of the present embodiment may generate different torsions according to the rotational state of the first rotating shaft 131 or the second rotating shaft 132, and the torsion could be released or decreased to the lowest level particularly when the electronic device 100 is in a folded state. In other words, compared to the unfolded state, the hinge structure 130 under the folded state may release the torsion to effectively prevent the deformation caused by the torsion.

Please refer to FIG. 4A, particularly the partial enlarged view. The first torsion hole C1 and the second torsion hole C2 of the torsion member 133 are formed respectively by bending a board with a thickness H1, and an orthogonal projection size of a maximum outer diameter of the first rotating shaft 131 onto the first torsion providing portion T5 (the flat hole wall of the first torsion hole CD is E1, and (E1)/(H1)=1.5˜5. Moreover, when the first torsion providing portion T5 abuts against the first actuating portion T1, a size of the orthogonal projection of the first actuating portion T1 onto the corresponding flat hole wall is E2, and (E1)/(E2)=1.2-5. Likewise, the ratio relationship mentioned above is also applicable to the corresponding relationship between the second rotating shaft 132 and the second torsion hole C2. The details would not be described again here.

FIG. 4C is a partial schematic view of the hinge structure in another state. Please refer to FIG. 4C. The first rotating shaft 131 is again taken as an example. In the present embodiment, when the first torsion providing portion T5 does not abut against the first actuating portion T1, the second actuating portion T2 abuts against at least two portions of the hole wall of the first torsion hole C1 shown as the contact surface D1 and the contact surface D2 in FIG. 4C. Likewise, when the second torsion providing portion T6 does not abut against the third actuating portion T3, the fourth actuating portion T4 abuts against at least two portions of the hole wall of the second torsion hole C2. Moreover, when the first torsion providing portion T5 does not abut against the first actuating portion T1, the coverage rate of the hole wall of the first torsion hole C1 wrapping around the axial surface of the first rotating shaft 131 is 0.2˜0.4. Likewise, when the second torsion providing portion T6 does not abut against the third actuating portion T3, the coverage rate of the hole wall of the second torsion hole C2 wrapping around the axial surface of the second rotating shaft 132 is 0.2˜0.4. What is required to be explained is that the coverage rate is defined by the accounted ratio of the cross section transferred by the sum of the contact surface D1 and the contact surface D2 to 360 degrees of the inscribed angle, which is (D1+D2)/360.

FIG. 4D is a partial schematic view of the hinge structure of another embodiment of the disclosure. Please refer to 4D. The difference between the present embodiment and the previous embodiments is that, to the torsion member 333, the end portion 333a of the wrapping type open structure is consistent with the normal direction 333b of the flat hole wall (which equals to the first torsion providing portion T5). Regarding the disposal of the end portion 333a, it prevents the first rotating shaft 131 from coming out of the torsion hole, and also provides an extra flat structure of the hole wall to support the first rotating shaft 131. Moreover, the end portion 333a also improves the coverage rate of the torsion member 333 to the first rotating shaft 131; meanwhile the end portion 333a may also provide the first rotating shaft 131 a required avoidance space while the rotating shaft 131 is rotating.

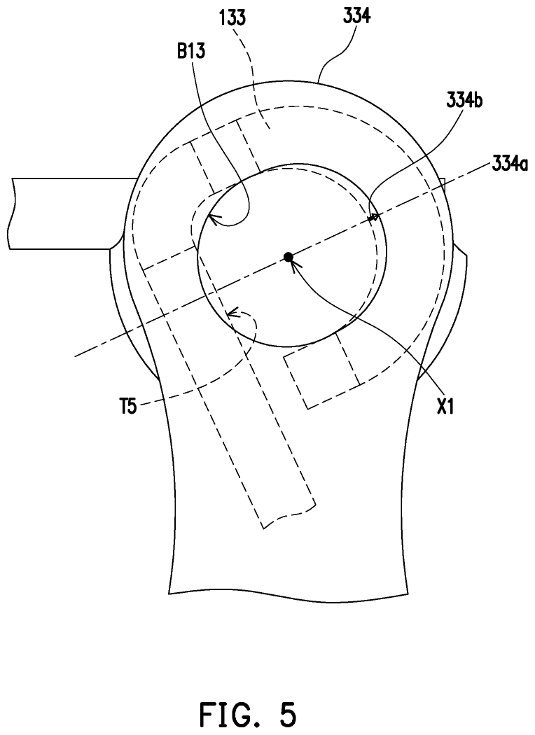

FIG. 5 is a partial side view of the hinge structure of another embodiment of the disclosure. The hinge structure of the present embodiment is similar to the ones shown by the aforementioned FIG. 2A and FIG. 2B. The hinge structure includes a torsion member 133 and a limiting member 334 of a switching assembly, wherein the limiting member 334 may be considered as the limiting member 134a or the torsion adjusting member 134e of the previous embodiments or a combination thereof. An axis X1 corresponding to the first rotating shaft 131 is taken as a basis (the actual contour of the first rotating shaft 131 is omitted in FIG. 5 and illustrated by the axis X1). In the present embodiment, the limiting member 334 of the switching assembly has a first guiding hole B13, and a cross section of the first guiding hole B13 is an ellipse; and the major axis of the ellipse is consistent with a normal direction 334a of the first torsion providing portion T5 (the flat hole wall of the torsion member 133). Therefore, the first guiding hole B13 would be able to provide the torsion member 133 with a required avoidance space when the deformation occurs due to the rotation of the rotating shaft; and the avoidance space is a deformation space 334b marked by a double-headed arrow in FIG. 5. The feature may effectively prevent the possibility of that the deformation of the torsion member 133 is obstructed by the limiting member due to the round shape of the torsion member; and thus avoid generating obstructions to the first rotating shaft 131, so as to be advantages to increase the stability of the torsion output and the structure when the first rotating shaft 131 is rotating. As mentioned above, the limiting member 334 may be considered as the limiting member 134a or the torsion adjusting member 134e of the aforementioned embodiments or a combination thereof. In other words, the first guiding hole B13 of the present embodiment may be used for at least one of the first guiding hole B1, the second guiding hole B2, the third torsion hole B3 and the fourth torsion hole B4 of the aforementioned embodiments.

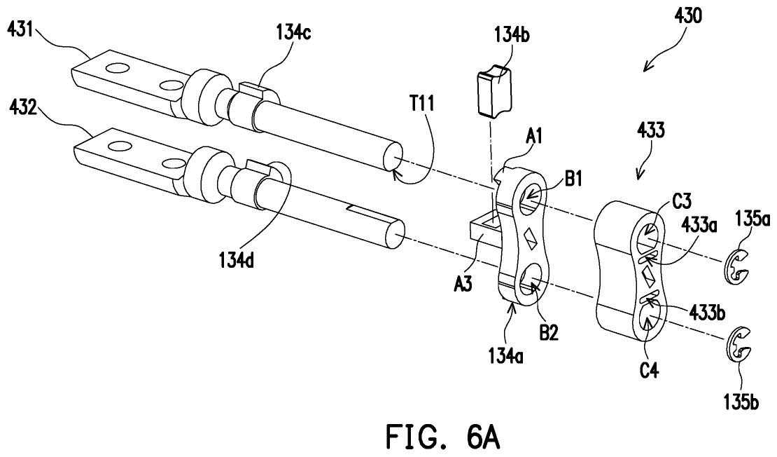

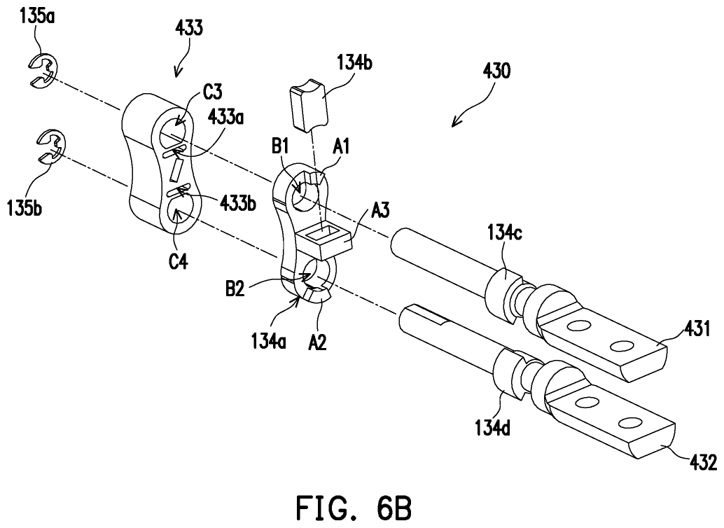

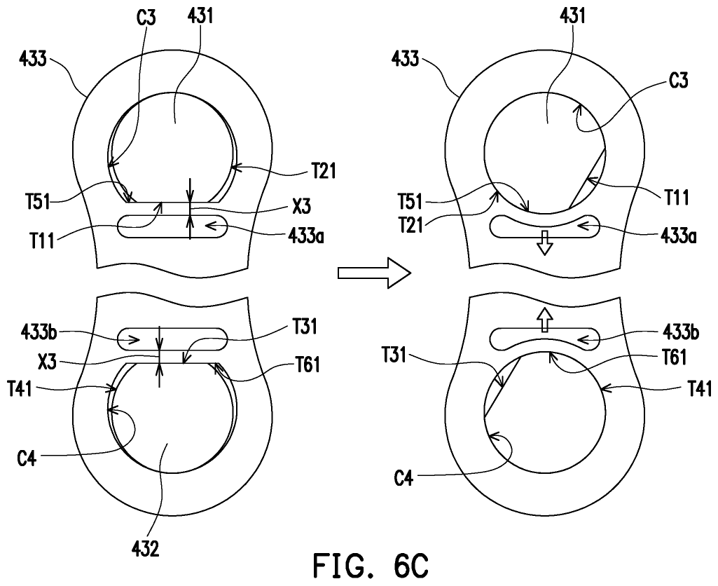

FIG. 6A and FIG. 6B are explosive views of the hinge structure of another embodiment of the disclosure. Please refer to FIG. 6A and FIG. 6B. What is required to be explained is that the structures or components of the present embodiment that are the same as that of the previous embodiments are marked with the same reference numerals; therefore, the differences between the present embodiment and the aforementioned embodiments lie in the torsion member 433. The torsion member 433 may be considered as an integral structure combined by the torsion member 133 and the torsion adjusting member 134e of the previous embodiments. FIG. 6C is a partial side view of the torsion member in FIG. 6A or FIG. 6B. Please refer to FIG. 6A to FIG. 6C simultaneously. In the present embodiment, a cross section of the first torsion hole C3 and a cross section of the second torsion hole C4 are respectively closed structures, and the torsion member 433 further has a first hollow portion 433a and a second hollow portion 433b respectively corresponding to the first torsion hole C3 and the second torsion hole C4. The torsion member 433 forms an elastic structure between the first torsion hole C3 and the first hollow portion 433a, and forms another elastic structure between the second torsion hole C4 and the second hollow portion 433b.

Further, to the first torsion hole C3, when the first torsion providing portion T51 (the flat hole wall) abuts against the second actuating portion T21 (the cylindrical surface), the first torsion providing portion T51 deforms towards the first hollow portion 433a. Likewise, when the second torsion providing portion T61 (the flat surface hole wall) abuts against the fourth actuating portion T41 (the cylindrical surface), the second torsion providing portion T61 deforms towards the second hollow portion 433b, and the deformation direction of the first torsion providing portion T51 as well as the deformation direction of the second torsion proving portion T61 (as shown by the arrows in FIG. 6C) are facing oppositely. Besides, the thickness of the elastic structure between the hollow portion 433a and the corresponding first torsion hole C3, or the elastic structure between the hollow portion 433b and the second torsion hole C4 is X3. The thickness ratio of the elastic structure to the average material of the torsion member 433 is 0.8˜1.5. What is required to be explained is that the corresponding relationship among the torsion hole, the hollow portion and the rotating shaft of FIG. 6A and FIG. 6B is also applicable to the torsion adjusting member 134e described by the previous embodiments, and may also achieve the effects of torsion releasing when the flat portion of the axial surface of the rotating shaft abuts against the flat hole wall of the torsion hole.

What is required to be explained is that although the structure adopted by the present application is partially different than the previous embodiments, the effects of deceasing the situation of interference between the structure and the torsion member is yielded when the rotating shaft is rotated to the specific location. For instance, switching from the right side of FIG. 6C to the left side of FIG. 6C may also provide the hinge structure with the required effects of torsion releasing corresponding to the folded state of the notebook computer.

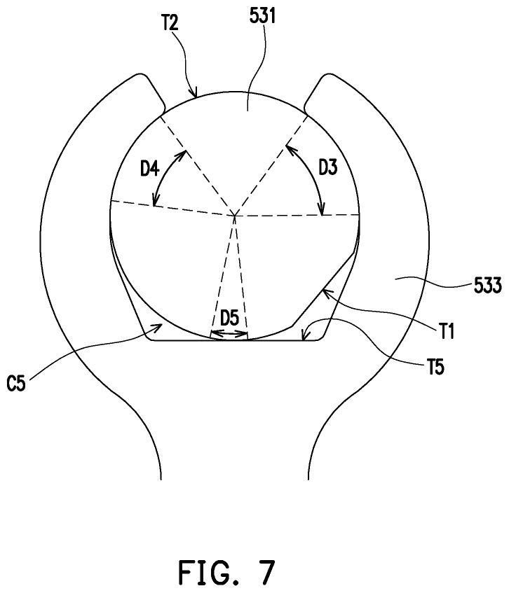

FIG. 7 is a partial schematic view of the hinge structure of another embodiment of the disclosure. As the previous embodiments, a first rotating shaft 531 has the first actuating portion T1 and the second actuating portion T2. The difference is that a first torsion hole C5 of a torsion member 533 is a symmetrical open contour (the second torsion hole of the torsion member 533 is as described above and would not be described again), and the torsion member 533 has the first torsion providing portion T5 and the second torsion providing portion (corresponding to the second torsion hole which is not shown here). When the first torsion providing portion T5 does not abut against the first actuating portion T1, the second actuating portion T2 abuts against at least three portions of the hole wall of the first torsion hole C5 as shown by the contact surfaces D3˜D5. What remains the same is that, at the moment, the coverage rate of the hole wall of the first torsion hole C5 wrapping around the axial surface of the first rotating shaft 531 is also 0.2-0.4 as mentioned by the previous embodiments, wherein the definition of the coverage rate has been described as above.

Based on the above, in the abovementioned embodiments of the disclosure, the adaptability of related structures of the electronic device could be increase through a torsion variation of the hinge structure so as to meet the requirement of rotation of the bodies. Particularly, when the bodies of the electronic device are in a folded state, the torsion of the hinge structure may be decreased or released to avoid the deformation of the bodies, and the bodies of the electronic device could further meet the design trend of slim and light.

The hinge structure is further defined by the cross-section contours of the rotating shaft and the torsion member and thereby causing the variation of the contour adaptability in the rotation process. In one of the embodiment, the torsion member has a torsion hole being an open structure, and has a flat hole wall and a cylindrical hole wall; and correspondingly, the axial surface of the rotating shaft has a flat portion and a cylindrical portion, such that the flat portion of the rotating shaft abuts against the flat hole wall of the torsion hole while the notebook computer being in the folded state of “0 degree”. Once the rotating shaft rotates to a state of non-0 degree, the torsion hole surrounds and grasps the axial surface of the rotating shaft, which also means the inference is occurred to generate torsion accordingly. Conversely, once the notebook computer is in a state of “0 degree”, it means that the rotating shaft at the moment is restored to the location of the flat portion abutting against the flat hole wall to release the torsion.

Although the disclosure has been disclosed in the above embodiments, the embodiments are not intended to limit the disclosure, and those skilled in the art may make some modifications and refinements without departing from the spirit and scope of the disclosure. Therefore, the scope of the disclosure is defined by the claims attached below.

What is claimed is:

1. A hinge structure, adapted to connect two bodies of an electronic device, the two bodies rotated relatively through the hinge structure to be folded or unfolded, and the hinge structure comprising:
a first rotating shaft, assembled to one of the bodies, having a first actuating portion and a second actuating portion;
a second rotating shaft, assembled to another one of the bodies, having a third actuating portion and a fourth actuating portion; and
a torsion member, having a first torsion providing portion and a second torsion providing portion, the first torsion providing portion is configured to abut on a moving path of the first actuating portion and the second actuating portion, and the second torsion providing portion is configured to abut on a moving path of the third actuating portion and the fourth actuating portion,
wherein the first rotating shaft and the second rotating shaft are respectively and rotatably disposed in the torsion member, and the torsion member respectively surrounds and grasps an axial surface of the first rotating shaft and an axial surface of the second rotating shaft, the first actuating portion and the second actuating portion are different portion of the axial surface of the first rotating shaft, the third actuating portion and the fourth actuating portion are different portion of the axial surface of the second rotating shaft,
wherein the torsion generated by the first torsion providing portion abutting the first actuating portion is smaller than the torsion generated by the first torsion providing portion abutting against the second actuating portion, and the torsion generated by the second torsion providing portion abutting the third actuating portion is smaller than the torsion generated by the second torsion providing portion abutting against the fourth actuating portion,
the first actuating portion is a flat portion of the axial surface of the first rotating shaft, and the third actuating portion is a flat portion of the axial surface of the second rotating shaft,
wherein the torsion member has a first torsion hole and a second torsion hole, the first rotating shaft is inserted into the first torsion hole, and the second rotating shaft is inserted into the second torsion hole,
wherein the first torsion providing portion is a flat portion of the hole wall of the first torsion hole, and the second torsion providing portion is a flat portion of the hole wall of the second torsion hole,
the hinge structure further comprising a switching assembly disposed next to the torsion member, wherein the switching assembly has a first guiding hole and a second guiding hole, the first rotating shaft is disposed through the first torsion hole and the first guiding hole, and the second rotating shaft is disposed through the second torsion hole and the second guiding hole,
wherein a cross section of the first guiding hole and a cross section of the second guiding hole are ellipses respectively, the major axis of the ellipse of the first guiding hole is consistent with a normal direction of the flat portion of the hole wall of the first torsion hole, and the major axis of the ellipse of the second guiding hole is consistent with a normal direction of the flat portion of the hole wall of the second torsion hole,
the switching assembly comprises:
a limiting member having a first limiting portion, a second limiting portion, the first guiding hole and the second guiding hole, wherein the first rotating shaft is disposed through the first guiding hole and corresponds to the first limiting portion, and the second rotating shaft is disposed through the second guiding hole and corresponds to the second limiting portion;
a third limiting portion and a fourth limiting portion respectively disposed on the first rotating shaft and the second rotating shaft to respectively rotate along with the first rotating shaft and the second rotating shaft, wherein the first limiting portion is located on the rotating path of the third limiting portion, and the second limiting portion is located on the rotating path of the fourth limiting portion; and
a switching member movably disposed on the limiting member, located between the first rotating shaft and the second rotating shaft, wherein opposite two ends of the switching member are respectively fitted to the first rotating shaft and the second rotating shaft to interfere the first rotating shaft or the second rotating shaft,
the hinge structure further comprising:
a torsion adjusting member disposed on the limiting member and located opposite to the switching member, wherein the first rotating shaft and the second rotating shaft are respectively disposed through the torsion adjusting member,
wherein the torsion adjusting member has a third torsion hole and a fourth torsion hole respectively corresponding to the first torsion hole and the second torsion hole, and the first rotating shaft and the second rotating shaft are disposed through the third torsion hole and the fourth torsion hole respectively,
wherein a cross section of the third torsion hole and a cross section of the fourth torsion hole are respectively closed structures,
wherein the torsion adjusting member further has a first hollow portion and a second hollow portion respectively being adjacent to the third torsion hole and the fourth torsion hole so as to form an elastic structure between the third torsion hole and the first hollow portion and another elastic structure between the fourth torsion hole and the second hollow portion.

2. The hinge structure according to claim 1, wherein the torsion adjusting member and the torsion member form an integral structure.

3. The hinge structure according to claim 1, wherein the hole wall of the third torsion hole comprises a flat wall and a cylindrical wall respectively corresponding to the first actuating portion and the second actuating portion, and the hole wall of the fourth torsion hole comprises another flat wall and another cylindrical wall respectively corresponding to the third actuating portion and the fourth actuating portion,
wherein when the first actuating portion abuts against the flat wall of the third torsion hole, the first hollow portion does not deform, and when the second actuating portion abuts against the flat wall of the third torsion hole, the first hollow portion deforms,
wherein when the third actuating portion abuts against the flat wall of the fourth torsion hole, the second hollow portion does not deform, and when the fourth actuating portion abuts against the flat wall of the fourth torsion hole, the second hollow portion deforms,
wherein the deformable direction of the first hollow portion and the deformable direction of the second hollow portion are opposite to each other.
